(19) United States
(12) Patent Application Publication
(10) Pub. No.: US 2004/0123281 A1
(43) Pub. Date: Jun. 24, 2004

(54) System, device, method and content package for upgrading a mobile communications terminal

(76) Inventors: Jakob Christian Olrik, Copenhagen O (DK); Mads Dalsgaard, Snekkersten (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/324,027

(22) Filed: Dec. 20, 2002

(51) Int. Cl. G06F 9/44

(52) U.S. Cl. 717/168

(57) ABSTRACT

A system for upgrading a mobile communications terminal includes a first computer and a database coupled to the first computer. The database contains a plurality of mobile communications terminal software items. The system also includes a second computer and a network having a first node and second node. The first computer is connected to the first node, and the second computer is connected to the second node. The plurality of mobile communications terminal software items of the database is accessible to the second computer over the network. The second computer is adapted to upgrade the mobile communications terminal by supplying it with at least a particular software item among the plurality of mobile communications terminal software items.

### FIELD OF THE INVENTION

The present invention relates to a system, a device, a method and a content package for upgrading a mobile communications terminal with at least a particular software item selected among a plurality of mobile communications terminal software items.

### BACKGROUND OF THE INVENTION

A mobile terminal in the form of a mobile (cellular) telephone for a telecommunications system like GSM, UMTS, D-AMPS or CDMA2000 is a familiar example of a mobile communications terminal according to the above.

U.S. Pat. No. 5,418,837 discloses a method and apparatus for upgrading the software of a mobile cellular telephone by temporarily connecting a software upgrading module (SUM) card to a card reader of the telephone. In a GSM telephone, the SIM (Subscriber Identity Module) card reader may be used. A CPU of the telephone is adapted to check, upon insertion of a card into the card reader, whether the card is an ordinary SIM card or a SUM card. In the latter case, upgrading software is read from a memory of the SUM card and is stored in a main memory of the telephone.

A drawback with the above is the manual intervention required for inserting the SUM card into the SIM card reader. This may require turning off the telephone, removing either a case lid or a battery, then carefully removing the SIM card from the card reader, inserting the SUM card in the card reader, mounting either the case lid or the battery, and finally turning the telephone back on. Moreover, since the SUM card must be filled with a specific content—a particular piece of upgrading software—this solution does not allow the user to have any influence on the selection of the upgrading software. In other words, personalization of the telephone by upgrading the software is not available according to this solution. In addition, since an individual SUM card itself carries the required upgrading software, the SUM card must be brought to the place where the telephone is.

WO01/93546 relates to a mobile terminal and, more particularly, to the issue of personalizing the terminal by allowing update of the ringtone or the idle-mode display background image from a computer. An external device, such as a camera or an instrumental keyboard, is connected to the computer so as to allow generation of the data that the terminal is to be updated with. The computer converts the generated data into a suitable format and transmits the converted data to the terminal through a datacall session over the mobile communications network (e.g. GSM), or through an SMS message or a WAP session. This solution allows remote upgrade of a mobile terminal without requiring the use of a local data carrier in direct physical contact with the terminal. It is however a non-flexible solution in that the data available for upgrading the terminal is limited to whatever data is currently input through the external device. It also requires active use of the external device, i.e. someone must operate the external device in order for the upgrade to take place. The terminal user cannot by himself request terminal upgrade with certain desired data, such as a specific image or ringtone, without having someone actually generating this data by means of the external device.

### SUMMARY OF THE INVENTION

In view of the above, an objective of the invention is to solve or at least reduce the problems discussed above. In more particular, a purpose of the invention is to provide an efficient, flexible and user friendly manner of upgrading a mobile communications terminal.

Generally, the above objectives are achieved by a system, a device, a method and a content package according to the attached independent patent claims.

A first aspect of the invention is a system for upgrading a mobile communications terminal, the system comprising:

a first computer;

a database coupled to said first computer, said database containing a plurality of mobile communications terminal software items;

a second computer;

a network having a first node and second node, said first computer being connected to said first node and said second computer being connected to said second node, wherein said plurality of mobile communications terminal software items of said database is accessible to said second computer over said network;

wherein said second computer is adapted to upgrade said mobile communications terminal by supplying it with at least a particular software item among said plurality of mobile communications terminal software items.

In one embodiment, the second computer is adapted to select said particular software item in response to a serial identity, article identity, model identity, type identity, version identity or release identity—or any combination thereof—of said mobile communications terminal. The second computer may have a user interface and be adapted to allow a user to select said particular software item by a selecting action through said user interface.

In one embodiment, the system comprises a second database coupled to said second computer, said second database being adapted to be repeatedly supplied with at least some of said plurality of mobile communications terminal software items and thus contain a replicated version of at least a portion of said database coupled to said first computer, wherein said second computer is adapted to upgrade said mobile communications terminal by supplying said particular software item from said second database.

The particular software item may include at least one of the following types: a still image such as an icon, a wallpaper, a picture or a logotype; a digital sound such as a ringtone or a piece of music; a video/audio sequence; program code for a processor of the mobile communications terminal, such as an electronic game, an application, an applet or a midlet; an electronic link such as a WAP bookmark; settings data for said mobile communications terminal, such as settings for a user interface thereof; or language data for a user interface of said mobile communications terminal.

In one embodiment, the second computer is adapted to upgrade said mobile communications terminal with a particular set of software items selected among said plurality of mobile communications terminal software items. The particular set of software items may include at least two software items of different ones of the types listed above. These at least two software items may have a certain selectable theme in common, which may relate to a social, cultural, geographical, political, historical, financial, technical or educational aspect of life or mankind.

The mobile communications terminal may be adapted for use in any one of the following mobile telecommunications systems: GSM, UMTS, D-AMPS or CDMA2000.

A second aspect of the invention is a method of upgrading a mobile communications terminal. The method comprises the steps of:

accepting a selection, over a network, of at least a particular software item among a plurality of mobile communications terminal software items;

delivering said particular software item over said network; and

upgrading the mobile communications terminal with said particular software item.

The method may further comprise the steps of

determining a serial identity, article identity, model identity, type identity, version identity or release identity of said mobile communications terminal; and

using the determined identity when selecting said particular software item.

The method may also comprise the steps of

receiving said selection of at least a particular software item from a user through a user interface; and

forwarding said selection over said network.

A third aspect of the invention is a device for upgrading a mobile communications terminal. The device comprises:

a retractable tray sized and designed to receive said mobile communications terminal when said tray is in an extended position;

a mechanism coupled to said tray for displacing said tray between said extended position and a retracted position;

an interface designed to interconnect with the mobile communications terminal when said tray is in its retracted position; and

means for supplying upgrading data over said inter-face to said mobile communications terminal.

The device may have a housing sized and designed to fit in a standard peripheral bay of a computer, such as a bay for a CD player, DVD player, diskette station or hard disk.

Said means for supplying upgrading data may be adapted to receive said upgrading data from a computer and forward it to said mobile communications terminal. It may comprise an interface for a computer bus such as ISA, EISA, VESA, IDE, PCI, PC Card, USB or Firewire.

A fourth aspect of the invention is a content package for upgrading a mobile communications terminal. Said content package comprises a set of mobile communications terminal software items having a certain selectable theme in common.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The present invention will now be described in more detail, reference being made to the enclosed drawings.

FIG. 1 is a schematic illustration of a system for upgrading a mobile communications terminal by way of a remote central database and an upgrading station in a retail shop.

FIGS. 2 and 3 are schematic illustrations of two alternative systems for upgrading a mobile communications terminal by way of a remote central database and an upgrading station, a local database and a local www server in a retail shop.

FIG. 4 is a schematic illustration of a software upgrading set with which a mobile communications terminal may be upgraded, the software upgrading set including core software, a language/settings pack and at least one content package.

FIG. 5 gives a couple of examples of different content packages that may be included in a software upgrading set of FIG. 4.

FIGS. 6-9 are perspective views of a device for upgrading a mobile communications terminal, the device being sized and designed to fit in a standard peripheral bay of a computer and having a retractable tray for accommodating the terminal.

FIG. 6 shows the retractable tray in an extended position, with no mobile communications terminal mounted in the tray.

FIG. 7 shows the retractable tray in its extended position and with a mobile communications terminal mounted in the tray.

FIG. 8 shows the retractable tray in its retracted position.

FIG. 9 is a view which corresponds to FIG. 6 but with the device housing removed so as to reveal the components inside the device.

FIG. 10 is an exploded view of the device shown in FIG. 9.

FIG. 11 is a side view of the device shown in FIG. 6.

FIG. 12 is a side view of the device shown in FIG. 8.

FIG. 13 is a perspective view of a standard-size computer having three peripheral bays, wherein one instance of the device for upgrading a mobile communications terminal according to FIGS. 6-12 is mounted in each of the three peripheral bays.

### DETAILED DESCRIPTION OF THE INVENTION

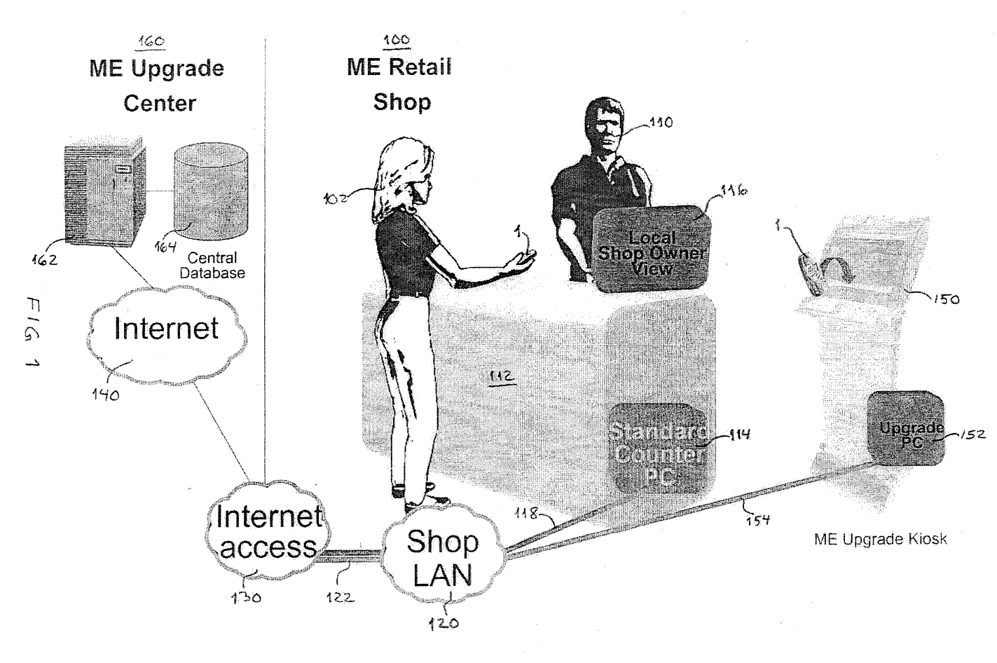

FIG. 1 illustrates a first embodiment of a system for upgrading a mobile communications terminal according to the invention. A mobile equipment (ME) retail shop 100 has a shop representative 110 such as a shop owner, manager or assistant, a counter 112 and a counter computer 114 including a counter computer monitor 116, all in a well known manner. The counter computer 114 is connected, as seen at 118, to a shop LAN (local area net-work) 120. The shop LAN is connected at 122 to the Internet 140 through an appropriate Internet access 130 such as ISDN, ASDL or any commercially available broad-band connection.

A mobile equipment upgrade kiosk 150 has an upgrade computer 152 which is connected to the shop LAN 120 and thus the Internet 140. Both the counter computer 114 and the upgrade computer 152 may be realized by commercially available personal computers (PCs).

A mobile equipment upgrade center 160 has a central upgrade server 162 and a central upgrade database 164 which, too, are connected to the Internet 140 and are thus accessible from the counter computer 114 and the upgrade computer 152 in the mobile equipment retail shop 100. The central upgrade database 164 stores a plurality of software items with which various models of mobile communications terminals may be upgraded.

A customer 102 may use the system described above for upgrading a mobile communications terminal 1 in the following manner. The customer 102 enters the retail shop 100 and hands the mobile communications terminal 1 over to the shop representative 110, who mounts the terminal 1 in or on the upgrade kiosk 150 so as to connect the terminal 1 to the upgrade computer 152. The connection between terminal 1 and upgrade computer .152 may be established in different ways. For instance, a dedicated accessory or reprogramming interface on the terminal 1 may be connected to a corresponding interface of the upgrade computer 152, or to an intermediate interface of the upgrade kiosk 150, which then will act so as to establish operative connection between terminal 1 and upgrade computer 152. The dedicated accessory or reprogramming interface on the terminal 1 may be an electrical contact, or a wireless interface such as infrared (e.g. IrDA) or short-range radio (e.g. Bluetooth). Detailed examples of the interconnection between terminal and upgrading computer will be given in the remaining drawings and later in the description of this invention.

The customer 102 and the shop representative 110 may discuss the particulars about the upgrade of the terminal 1. As previously mentioned, the upgrade may consist in adding or substituting certain software items of the terminal, including but not limited to: a still image such as an icon, a wallpaper, a picture or a logotype; a digital sound such as a ringtone or a piece of music; a video/audio sequence; program code for the terminal 1, such as an electronic game, an application, an applet or a midlet; an electronic link such as a WAP bookmark; and settings data and/or language data for the user interface of the terminal 1. A visual summary of available software items may be presented as graphics and/or text on the counter computer monitor 116 for the convenience of the customer 102 and the shop representative 110.

Once the customer 102 and the shop representative 110 have agreed upon the particulars about the terminal upgrade, the shop representative 110 may specify the required details in terms of selected software items, payment or billing details, etc, through the counter computer 114 and then initiate the actual upgrade procedure by passing the required details on to the upgrade computer 152 over the shop LAN 120. In response, the upgrade computer 152 may connect to the mobile equipment upgrade center 160 and download the selected software items from the central upgrade database 164 as well as report the specified payment or billing details, etc, to the central upgrade server 162 for further financial processing therein.

As the selected software items have been downloaded, wholly or partially, to the upgrade computer 152, this computer will establish contact with the terminal 1 via aforesaid interconnection. A predetermined software upgrading routine will be executed in the terminal 1 and control the actual upgrading of the terminal, which may involve modifying the contents of a persistent memory in the terminal 1 with the selected software items. The persistent memory may for instance be a flash memory or an (E)EPROM memory.

The mobile communications terminal 1 may be a mobile(cellular) telephone for any commercially available mobile telecommunications system, such as GSM, UMTS, D-AMPS or CDMA2000. The mobile communications terminal 1 may alternatively be another kind of mobile equipment, such as a portable digital assistant (PDA) or a communicator.

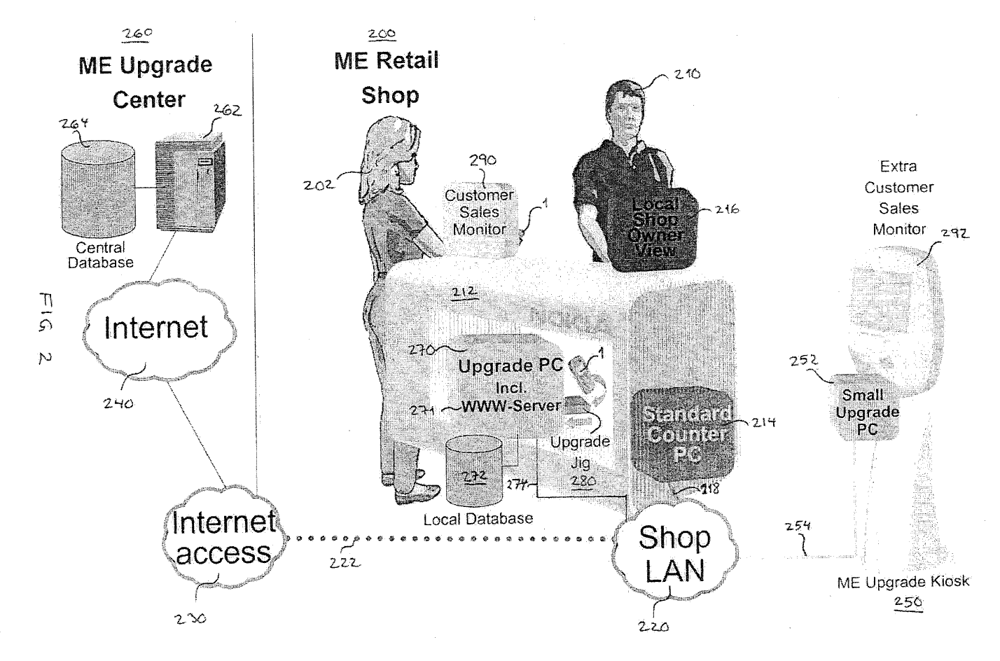

FIGS. 2 and 3 illustrate a second embodiment and a third embodiment, respectively, of a system for upgrading a mobile communications terminal according to the invention. Like reference numerals in FIGS. 2 and 3 represent like reference numerals in FIGS. 1, such that for instance reference numeral 260/360 in FIGS. 2 and 3, respectively, corresponds to 160 in FIG. 1. Unless explicitly specified, the elements represented by such like reference numerals do not differ substantially from each other, and a lengthy repetition of the description thereof is avoided.

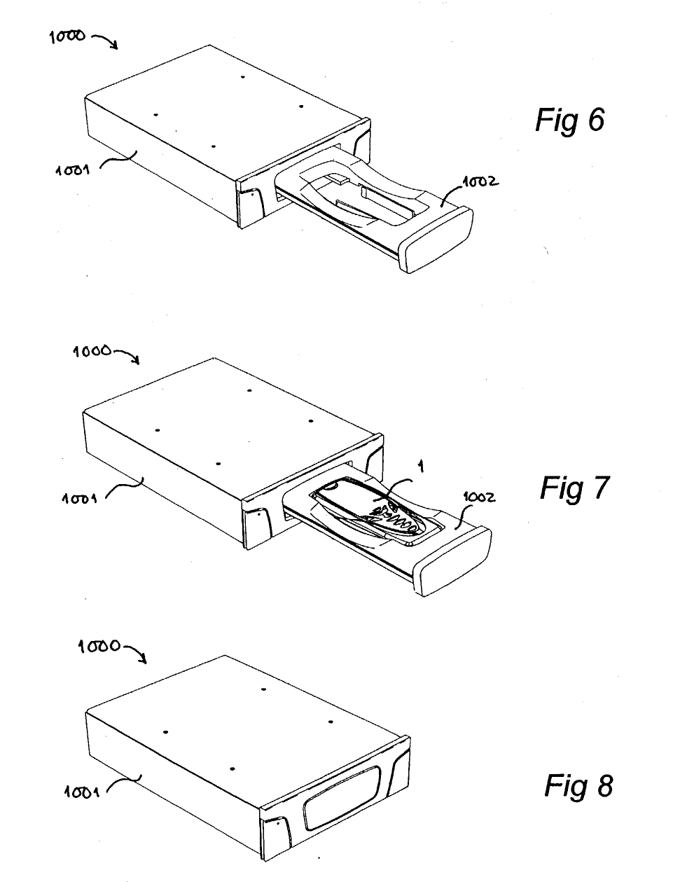

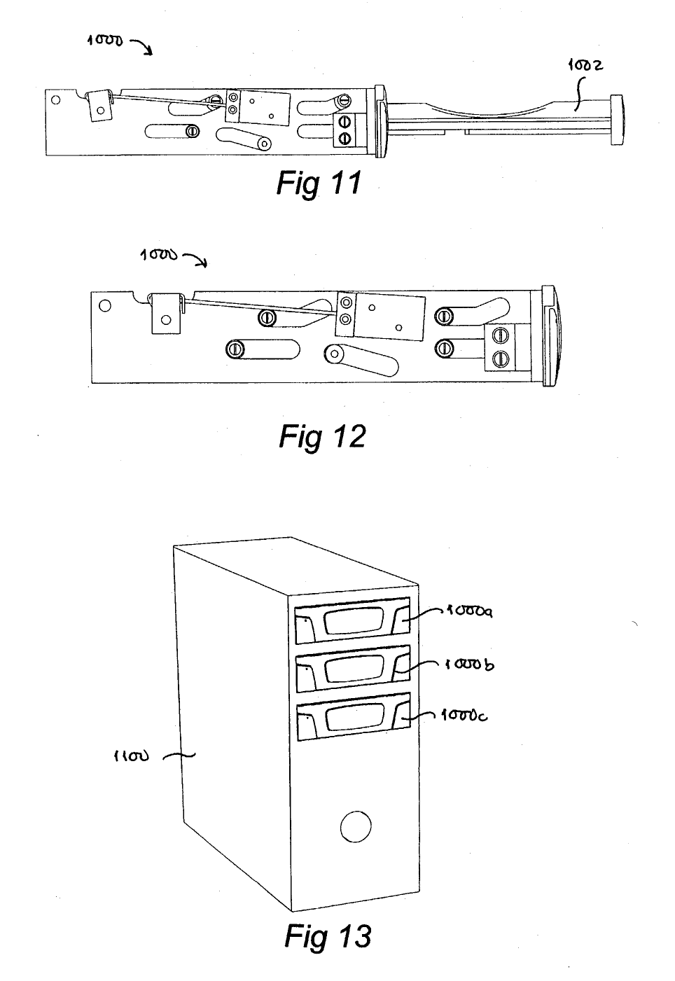

In the system of FIG. 2 the mobile equipment retail shop 200 has an upgrade computer 270 which provides extended functionality, compared to the upgrade computer 152 of FIG. 1, by incorporating an upgrading device (referred to as upgrade jig 280 in FIG. 2), in which the terminal 1 may be conveniently mounted for upgrade. The upgrading device 280 will be described in more detail with reference to FIGS. 6-13.

In addition to the above, the upgrade computer 270 has a local upgrade database 272 which contains a replicated version of at least a portion of the central upgrade database 264. The upgrade computer 270 includes a local www server 271, thereby allowing the customer 202 to use a customer sales monitor 290 for convenient selection of the one(s) of the available software items with which the terminal 1 is to be upgraded. The provision of a local www server 271 allows the upgrade kiosk 250 to provide an extra customer sales monitor 292 at an upgrade kiosk 250. A small upgrade computer 252 thereof corresponds essentially to the upgrade computer 152 of FIG. 1.

The system of FIG. 2 has several advantages. By the provision of a local upgrade database 272, less capacity is required for the Internet connection 222, since it will only need to be used during replication of the data from the central upgrade database 264. This may, for instance, occur one or a few times daily, and thus no permanent Internet connection is required.

The customer 202 may be given one view, through any of the customer sales monitors 290 or 292, of what software items can be downloaded as well as their prices, and the shop representative 210 may be given another view, through the counter computer monitor 216, of what software items the customer has chosen, the price thereof, payment or billing data as well as control information required to start the upgrading of the terminal 1. In this scenario, the customer 202 may first consult a customer view for a presentation of the available software, then make a selection of the desired software items and, optionally, also of the means and terms of payment, and finally hand the terminal 1 over to the shop representative 210. The means and terms of payment may concern electronic payment and thus relate to credit card information, mobile subscription information, account information or even digital/virtual money such as cyber dollars. Alternatively, the means and terms of payment may concern traditional payment by cash or check.

The shop representative 210 may then check what selections the customer has made and, optionally, whether sufficient details about the means and terms of payment have been provided or alternatively whether a sufficient cash or check amount has been provided, as the case may be. If everything is in order, the shop representative 210 may insert the customer's terminal 1 into the upgrading device 280 of the upgrade computer 270, as indicated in FIG. 2, to start upgrading the terminal. As an alternative, the customer 202 himself may insert the terminal 1 into the upgrading device 280 or a corresponding terminal-receiving part of the upgrade kiosk 250, wherein the shop representative's actions may be limited to verifying the selection/payment data specified by the customer and commanding initiation of the upgrading procedure.

The third embodiment of FIG. 3 is a self-service version of the second embodiment of FIG. 2. In FIG. 3, there is no shop representative and no counter involved. Instead, a customer 302 may use any of a number of stand-alone upgrade kiosks 350, 350′ on a self-service basis. Each stand-alone upgrade kiosk has an upgrading device 380, 380′ and a customer sales monitor 392, 392′. An upgrade computer 370 with a local upgrade database 372 and a local www server 371 may be placed together with one of the upgrade kiosks, as shown in FIG. 3, or may be separately connected to the shop LAN 320. Through any of the stand-alone upgrade kiosks 350, 350′ the customer 302 may perform the relevant ones of the steps described in conjunction with FIG. 2 so as to upgrade his terminal 1. More specifically, one possible sequence of steps is mounting of the terminal 1 in the upgrading device 380/380′, selecting on the customer sales monitor 392/392′ the desired software items, specifying the means and terms of payment, awaiting verification of the specified means and terms of payment (which may be done either locally by e.g. the local www server 371/database 372 or remotely by the mobile equipment upgrade center 360), confirming the order of the selected software items and the requested price thereof, waiting for the upgrade procedure to be performed and, finally, retrieving the upgraded terminal 1 from the upgrading device 380/380′.

Generally, the mobile equipment retail shop in the embodiments of FIGS. 1-3 may include an arbitrary number of the different pieces of equipment, i.e. one or more than one upgrade computer, upgrade kiosk, counter computer, local database, computer sales monitor, upgrade device (jig), etc. Correspondingly, the mobile equipment upgrade center may have a distributed and/or hierarchical architecture, possible involving more than one upgrade server, upgrade database, etc, for instance reflecting a geographical structure of different areas/countries/regions. A large number of mobile equipment retail shops may be connected to one mobile equipment upgrade center.

The central upgrade database may contain upgrading software for various terminal models, types, versions, releases, etc. Not all of this software needs to be replicated to the local upgrade database of a particular mobile equipment retail shop, but only those software items that are designed for the relevant models, types, versions or releases that are sold in the area, country or region in which the particular retail shop is located. To this end, the upgrading device/upgrade computer/upgrade kiosk may determine a serial identity, article identity, model identity, type identity, version identity or release identity—or any combination thereof—for the terminal upon connection with the same. Determination of such an identity will facilitate selection of the appropriate software items to be offered for upgrade and will also make it easier to avoid that the terminal is upgraded with an incorrect or incompatible software item which is not designed for the current model, type, version or release of the terminal or the application and operating software therein.

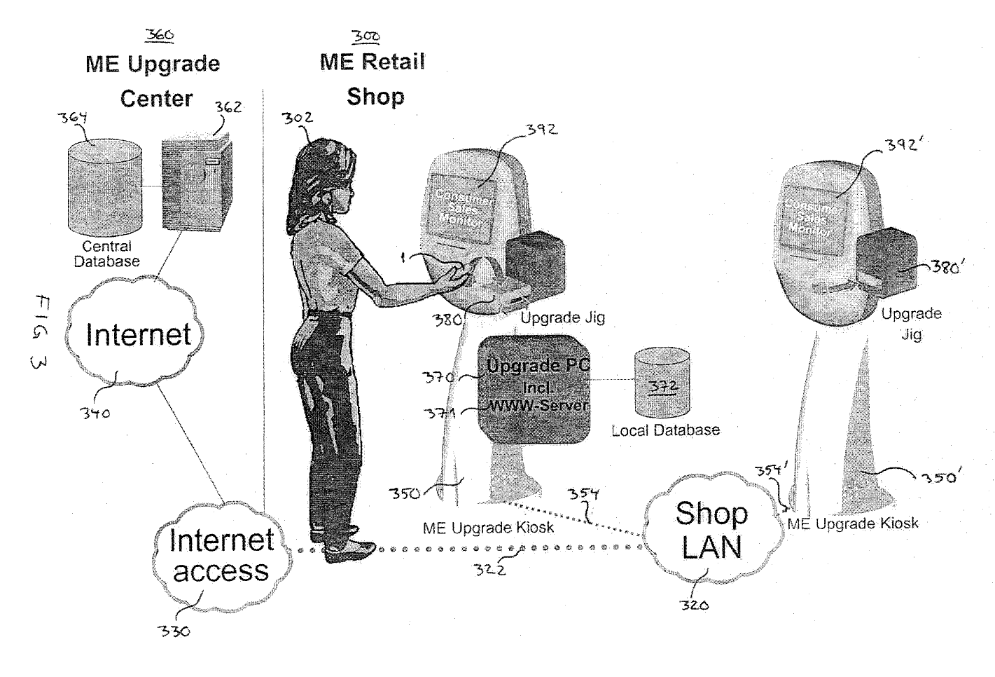

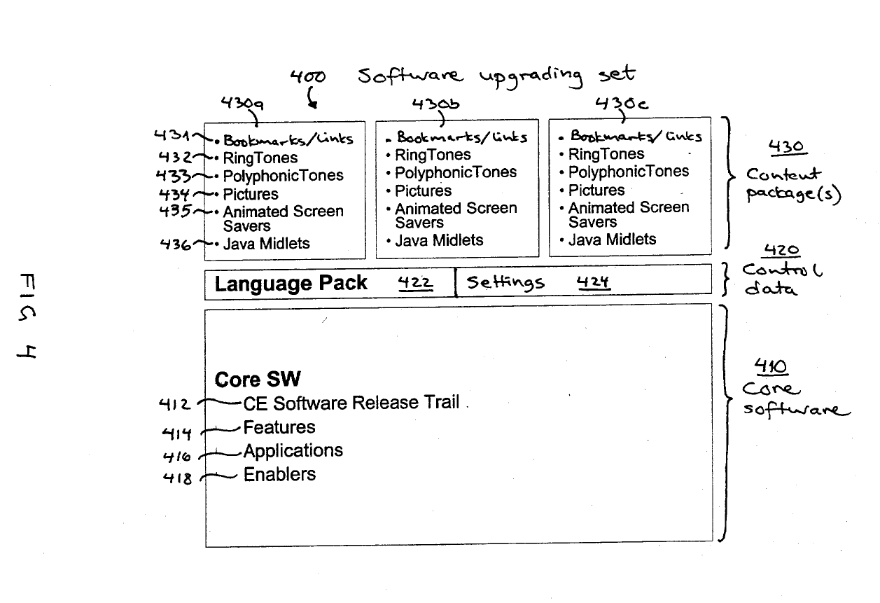

FIG. 4 is a schematic illustration of a software upgrading set 400 with which a mobile communications terminal may be upgraded in any of the manners described above. The software upgrading set may include various software items, generally related to three different levels 410, 420, 430 of the software hierarchy of a mobile communications terminal. Core software 410 represent a basic level and may include a CE software release trail 412 which in itself may include various operating system software items. The core software 410 may also include various features 414, applications 416 and enablers 418.

Control data 420 represents a higher level and may include a language pack 422 and settings 424. The language pack may relate to various texts in the user interface of the terminal, such as menu item names, help texts, etc. Settings 424 may define a certain setup of the terminal, for instance email access settings, WAP access settings, mobile communications network settings, user interface settings, etc.

At least one content package 430a-c may be provided at a still higher level of the software upgrading set 400. As seen in FIG. 4, each content package may include electronic links 431 such as WAP or http bookmarks; digital sounds such as ringtones 432, polyphonic ringtones 433 or pieces of music; still images such as icons, wallpapers, pictures 434 or logotypes; animated video/audio sequences such as screen savers 435; and program code for a processor of the mobile communications terminal, such as an electronic game, an application, an applet or a Java midlet 436. Program code may also be included in the core software 410, as has been explained above. Not all three levels need to be represented in a particular software upgrading set. On the contrary, as little as a single software item may constitute the software upgrading set.

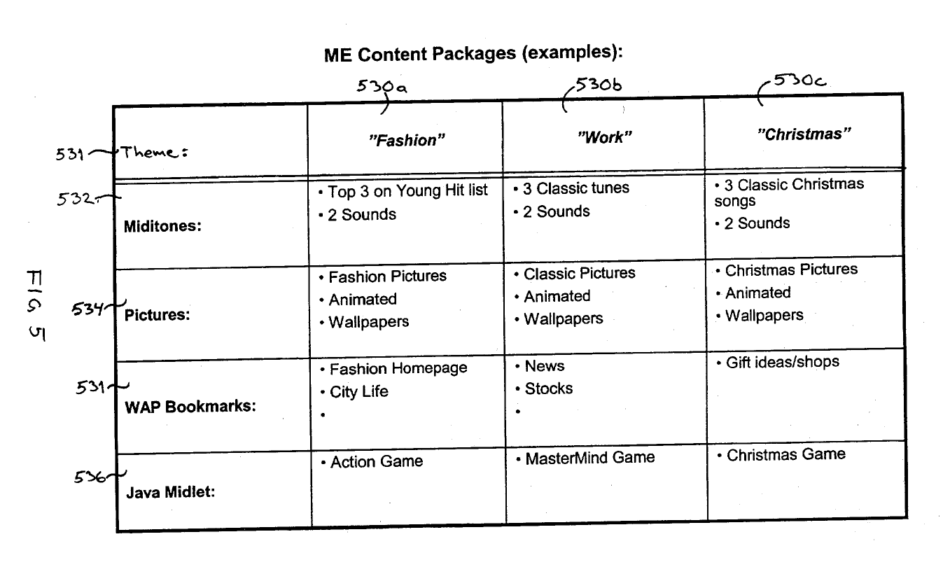

FIG. 5 gives some more detailed examples of how the content packages 430a-c/530a-c may be designed. Advantageously, the contents of each content package may have a certain theme 531 in common. Thus, various software items may be offered to the customer as specific theme kits, wherein each theme kit will contain software items that all have share an identifiable theme. FIG. 5 gives three examples of such themes: “Fashion” (530a), “Work” (530b) and “Christmas” (530c). Other examples may be a certain pop star, rock group, movie or sports event. Of course, the number of possible themes is virtually unlimited; themes may for instance relate to social, cultural, geographical, political, historical, financial, technical or educational aspects of life or mankind.

One embodiment 1000 of the upgrading device 280/380 will now be described in more detail with reference to FIGS. 6-13. As seen in FIG. 13, the upgrading device according to this embodiment is sized and designed to fit in a standard peripheral bay of a computer 1100 (such as the upgrade computer 270/370 of FIGS. 2-3). In fact, more than one upgrading device 1000a-c may advantageously be included in such a computer so as to allow parallel upgrade of a corresponding number of terminals.

The upgrading device 1000 has a retractable terminal tray 1002 in which the terminal 1 to be upgraded is mounted by a user, such as the customer or the shop representative. The terminal tray 1002 is displaceable between an extended position, as shown in FIGS. 6-7, and a retracted position, as shown in FIGS. 8. Mounting of the terminal 1 before upgrade, and dismounting of the terminal after upgrade, occur in the extended position of the terminal tray 1002, whereas the actual upgrade occurs in its retracted position. It may be necessary to remove some housing part of the terminal, such as a rear cover and/or a battery pack, prior to the mounting of the terminal in the terminal tray.

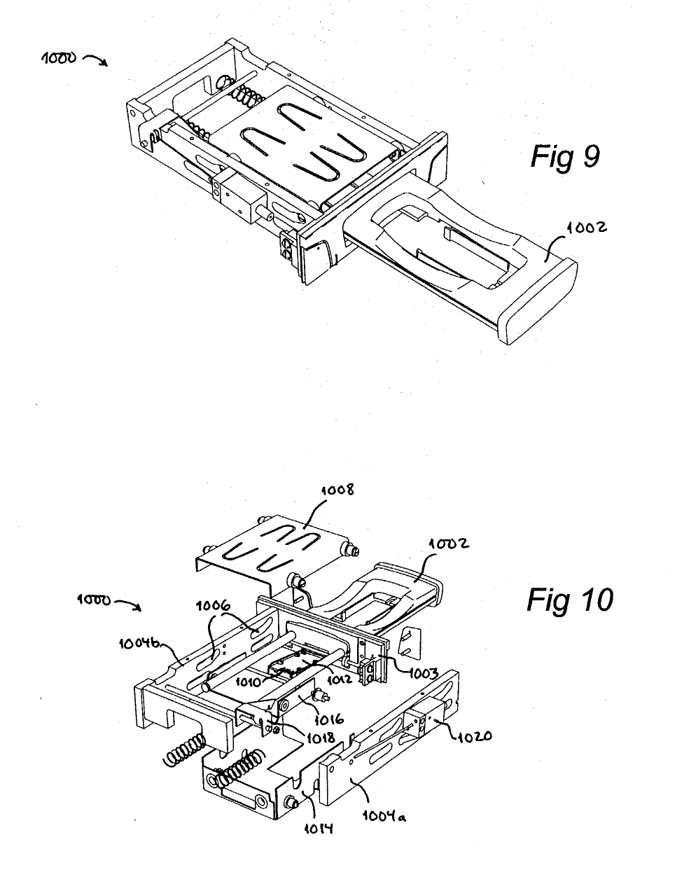

As seen in FIGS. 9-12, the upgrading device 1000 has a front 1003 which is fixed to two identical guiders 1004a-b having some curves 1006 that control the movement and direction of three drawers. A top drawer 1008 functions to hold the inserted terminal 1 in the terminal tray 1002 in a fixed position when the contacts 1010 of a printed circuit board 1012 make contact with corresponding contacts of the terminal 1. A bottom drawer 1014 controls the top drawer's movement in the longitudinal direction. When the bottom drawer 1014 moves from an outer to an inner position, the top drawer 1008 moves down and touches the terminal 1, thereby keeping it fixed in the terminal tray 1002 during upgrade of the terminal 1.

A contact drawer 1016 has a turning point at an inner end of the wheels of the bottom drawer 1014. The other end of the contact drawer 1016 is guided at a single bottom curve of the guiders 1004a-b. This means that when the bottom drawer 1014 moves from its outer position and in, the top drawer 1008 first fixes the terminal 1 as described above. Then the contact drawer 1016, guided at the curve in the guiders 1004a-b, moves into the terminal 1 where it connects data signal and power connection with the terminal 1.

The bottom drawer 1014 is fixed in its inner position by a catch 1018, and the catch is released when current is switched on to a solenoid coil 1020 from either a micro switch at the front 1003 or from the computer 1100.

The printed circuit board 1012 comprises an interface for a computer bus such as ISA, EISA, VESA, IDE, PCI, PC Card, USB or Firewire and is thus operatively connected to the computer 1100. The computer 1100 has an interface to the shop LAN 220/320 and may thus receive the data, i.e. the selected software item(s), with which the terminal 1 is to be upgraded. The computer 1100 also runs a terminal upgrading software that handles the communication of upgrading data and instructions between upgrading device 1000, local www server 271/371 and local upgrade database 272/372. The computer 1100 may also run software to implement the local www server 271/371 and/or local upgrade database 272/372 and may, in such a case, also handle the replication of the central upgrade database 264/364 onto the local upgrade database 272/372.

Giving users the possibility to somewhat regularly come in and update the contents of the mobile communications terminals also provides for the opportunity to keep track of an individual mobile communications terminal. The mobile communications terminal maintains a special log of actions undertaken and errors encountered, in effect forming a history list. When the terminal is connected to the upgrading device, this history list may be transferred over to the mobile terminal upgrade center and then be forwarded to a given technical site. Here, developers can make valuable use of the collected history data, for instance to learn in what situations errors occur, the particulars of the occurring errors and how frequently they occur.

The invention has mainly been described above with reference to a few embodiments. However, as is readily appreciated by a person skilled in the art, other embodiments than the ones disclosed above are equally possible within the scope of the invention, as defined by the appended patent claims.

What we claim and desire to secure by letters patent is:

1. A system for upgrading a mobile communications terminal, the system comprising:
a first computer;
a database coupled to said first computer, said database containing a plurality of mobile communications terminal software items;
a second computer;
a network having a first node and second node, said first computer being connected to said first node and said second computer being connected to said second node, wherein said plurality of mobile communications terminal software items of said database is accessible to said second computer over said network;
wherein said second computer is adapted to upgrade said mobile communications terminal by supplying it with at least a particular software item among said plurality of mobile communications terminal software items.

2. The system as defined in claim 1, wherein said second computer is adapted to select said particular software item in response to a serial identity, article identity, model identity, type identity, version identity or release identity or any combination thereof—of said mobile communications terminal.

3. The system as defined in claim 1, said second computer having a user interface and being adapted to allow a user to select said particular software item by a selecting action through said user interface.

4. The system as defined in claim 1, further comprising a second database coupled to said second computer, said second database being adapted to be repeatedly supplied with at least some of said plurality of mobile communications terminal software items and thus contain a replicated version of at least a portion of said database coupled to said first computer, wherein said second computer is adapted to upgrade said mobile communications terminal by supplying said particular software item from said second database.

5. The system as defined in claim 1, wherein said particular software item includes at least one of the following types: a still image such as an icon, a wallpaper, a picture or a logotype; a digital sound such as a ringtone or a piece of music; a video/audio sequence; program code for a processor of the mobile communications terminal, such as an electronic game, an application, an applet or a midlet; an electronic link such as a WAP bookmark; settings data for said mobile communications terminal, such as settings for a user interface thereof; or language data for a user interface of said mobile communications terminal.

6. The system as defined in claim 1, wherein said second computer is adapted to upgrade said mobile communications terminal with a particular set of software items selected among said plurality of mobile communications terminal software items.

7. The system as defined in claim 6, wherein said particular set of software items includes at least two software items of different ones of the types listed in claim 5.

8. The system as defined in claim 7, wherein said at least two software items have a certain selectable theme in common.

9. The system as defined in claim 8, wherein said selectable theme relates to a social, cultural, geographical, political, historical, financial, technical or educational aspect of life or mankind.

10. The system as defined in claim 11, wherein said mobile communications terminal is adapted for use in any one of the following mobile telecommunications systems: GSM, UMTS, D-AMPS or CDMA2000.

11. A method of upgrading a mobile communications terminal, the method comprising the steps of:
accepting a selection, over a network, of at least a particular software item among a plurality of mobile communications terminal software items;
delivering said particular software item over said network; and
upgrading the mobile communications terminal with said particular software item.

12. A method as in claim 11, further comprising the steps of
determining a serial identity, article identity, model identity, type identity, version identity or release identity of said mobile communications terminal; and
using the determined identity when selecting said particular software item.

13. A method as in claim 11, further comprising the steps of
receiving said selection of at least a particular software item from a user through a user interface; and
forwarding said selection over said network.

14. A method as in claim 11, wherein said particular software item includes at least one of the following types: a still image such as an icon, a wallpaper, a picture or a logotype; a digital sound such as a ringtone or a piece of music; a video/audio sequence; program code for a processor of the mobile communications terminal, such as an electronic game, an application, an applet or a midlet; an electronic link such as a WAP bookmark; settings data for said mobile communications terminal, such as settings for a user interface thereof; or language data for a user interface of said mobile communications terminal.

15. A method as in claim 11, wherein said steps of accepting, delivering and upgrading are performed for a particular set of software items selected among said plurality of, mobile communications terminal software items, said particular set of software items including at least two software items of different ones of the types listed in claim 14, said at least two software items having a certain selectable theme in common.

16. A method as in claim 15, wherein said selectable theme relates to a social, cultural, geographical, political, historical, financial, technical or educational aspect of life or mankind.

17. A device for upgrading a mobile communications terminal, said device comprising:
a retractable tray sized and designed to receive said mobile communications terminal when said tray is in an extended position;
a mechanism coupled to said tray for displacing said tray between said extended position and a retracted position;
an interface designed to interconnect with the mobile communications terminal when said tray is in its retracted position; and
means for supplying upgrading data over said interface to said mobile communications terminal.

18. The device as defined in claim 17, further comprising a housing sized and designed to fit in a standard peripheral bay of a computer, such as a bay for a CD player, DVD player, diskette station or hard disk.

19. The device as defined in claim 17, wherein said means for supplying upgrading data is adapted to receive said upgrading data from a computer and forward it to said mobile communications terminal.

20. The device as defined in claim 19, wherein said means for supplying upgrading data comprises an interface for a computer bus such as ISA, EISA, VESA, IDE, PCI, PC Card, USB or Firewire.

21. The device as defined in claim 17, wherein said upgrading data includes at least one of the following: a still image such as an icon, a wallpaper, a picture or a logotype; a digital sound such as a ringtone or a piece of music; a video/audio sequence; program code for a processor of the mobile communications terminal, such as an electronic game, an application, an applet or a midlet; an electronic link such as a WAP bookmark; settings data such as settings for a user interface of said mobile communications terminal; or language data for said user interface of said mobile communications terminal.

22. A content package for upgrading a mobile communications terminal, said content package comprising a set of mobile communications terminal software items having a certain selectable theme in common.

23. The content package as defined in claim 22, wherein said selectable theme relates to a social, cultural, geographical, political, historical, financial, technical or educational aspect of life or mankind.

24. The content package as defined in claim 22, said set of mobile communications terminal software items including at least two software items of different ones of the following types: a still image such as an icon, a wallpaper, a picture or a logotype; a digital sound such as a ringtone or a piece of music; a video/audio sequence; program code for a processor of the mobile communications terminal, such as an electronic game, an application, an applet or a midlet; an electronic link such as a WAP bookmark; settings data such as settings for a user interface of said mobile communications terminal; or language data for said user interface of said mobile communications terminal.
